(19) United States
(12) Patent Application Publication
(10) Pub. No.: US 2004/0044795 A1
(43) Pub. Date: Mar. 4, 2004

(54) Wire extension device

(76) Inventor: Tung-Liang Li, Tainan (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/223,435

(22) Filed: Aug. 19, 2002

(51) Int. Cl. G06F 15/16

(52) U.S. Cl. 709/250

(57) ABSTRACT

A wire extension device has a socket module and an ETHERNET module. The wire extension device is used as a transmission medium between a network and a source of electricity. When two computers use the wire extension device, a data transmission of a network will be transmitted through the ETHERNET module.

### BACKGROUND OF THE INVENTION

The present invention relates to a wire extension device. More particularly, the present invention relates to a wire extension device which combines a socket module and an ETHERNET module.

A conventional wire extension device has a socket module only. A data transmission of a network should be transmitted through a telephone cable. Even if two computers use the same conventional wire extension device, the data transmission of the network are still transmitted through the telephone cable.

### SUMMARY OF THE INVENTION

An object of the present invention is to provide a wire extension device which combines a socket module and an ETHERNET module so that the wire extension device will become a network interface and a network socket. When two computers use the same wire extension device, a data transmission of a network will be transmitted through the ETHERNET module which has a high speed transmission electric wire.

When two computers use two wire extension devices, a data transmission of a network will be transmitted through a wire carrier wave method.

### BRIEF DESCRIPTION OF THE DRAWINGS

FIG. 1 is a schematic view of a wire extension device of a preferred embodiment in accordance with the present invention; and

FIG. 2 is a schematic view of two wire extension devices of a preferred embodiment in accordance with the present invention.

### DETAILED DESCRIPTION OF THE INVENTION

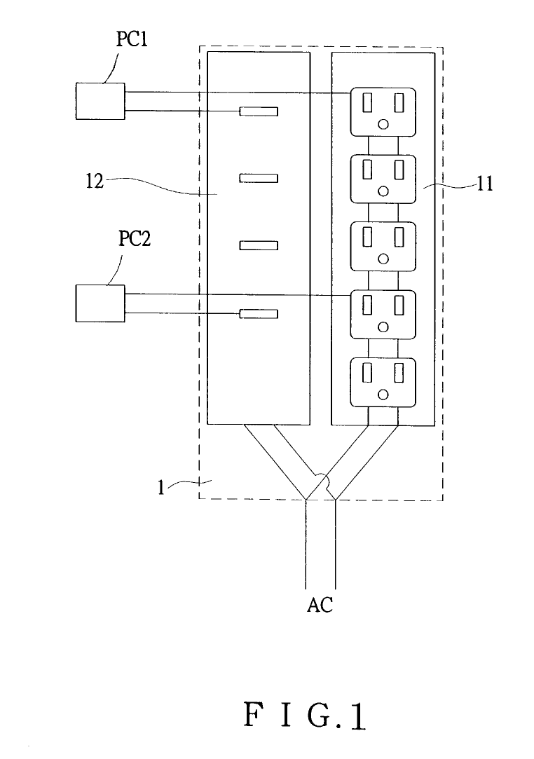

Referring to FIG. 1, a first wire extension device 1 comprises a socket module 11 and an ETHERNET module 12.

The first wire extension device 1 is used as a transmission medium between a network and a source of electricity.

When a first computer PC1 and a second computer PC1 use the same wire extension device, a data transmission of a network will be transmitted through the ETHERNET module.

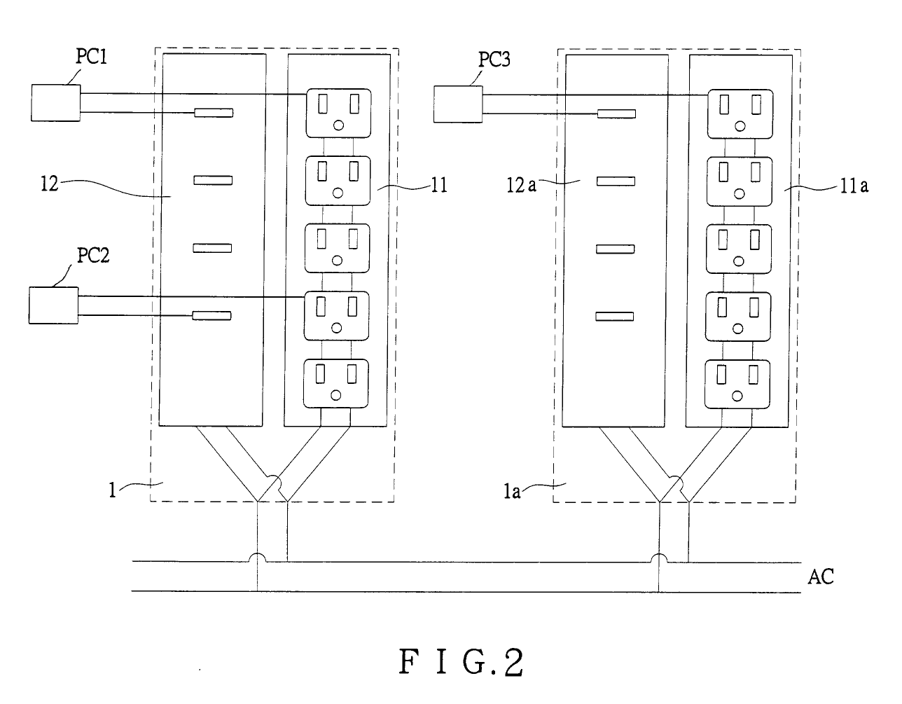

Referring to FIG. 2, a second wire extension device 1a comprises another socket module 11a and another ETHERNET module 12a.

The second wire extension device 1a is used as a transmission medium between a network and a source of electricity.

When a third computer PC3 uses the second wire extension device 1a and the first computer PC1 uses the first wire extension device 1, a data transmission of a network will be transmitted through a wire carrier wave method.

If the first computer PC1 and the second computer PC1 are personal computers and the third computer PC3 is a notebook computer, the first computer PC1 and the second computer PC1 should use the first wire extension device 1 and the third computer PC3 should use the second wire extension device 1a. Then a data transmission between the first computer PC1 and the third computer PC3 will be transmitted through the wire carrier wave method.

Furthermore, the socket module 11 and the ETHERNET module 12 can be extended.

The invention is not limited to the above embodiment but various modification thereof may be made. Further, various changes in form and detail may be made without departing from the scope of the invention.

I claim:

1. A wire extension device comprising a socket module and an ETHERNET module, characterized in that:
the wire extension device is used as a transmission medium between a network and a source of electricity,
when two computers use the wire extension device, a data transmission of a network will be transmitted through the ETHERNET module.
